(19) United States
(12) Patent Application Publication
(10) Pub. No.: US 2015/0248605 A1
(43) Pub. Date: Sep. 3, 2015

(54) DISPOSABLE RFID RACE BIB TIMING DEVICE

(71) Applicant: CHRONOTRACK SYSTEMS, CORP., Chanhassen, MN (US)

(72) Inventors: Daniel R. Howell, Newburgh, IN (US); Arash Kia, Portland, OR (US)

(21) Appl. No.: 14/712,317

(22) Filed: May 14, 2015

Related U.S. Application Data
(63) Continuation-in-part of application No. 13/827,712, filed on Mar. 14, 2013, now abandoned.
Application No. 13/827,712 is a continuation of application No. 13/206,253, filed on Aug. 9, 2011, now abandoned.
Application No. 13/206,253 is a continuation of application No. 12/077,490, filed on Mar. 20, 2008, now abandoned.
Application No. 12/077,490 is a continuation-in-part of application No. 12/856,587, filed on Aug. 14, 2010.
Application No. 12/856,587 is a continuation-in-part of application No. 12/732,590, filed on Mar. 26, 2010.
(60) Provisional application No. 60/936,740, filed on Jun. 22, 2007.

(51) Int. Cl. G06K 19/07; A63F 9/14

(52) U.S. Cl. CPC G06K 19/0725; A63F 9/14

(57) ABSTRACT

A disposable race bib timing device is provided including a thin, flexible planar sheet member having a front surface for displaying information, and a rear surface. An RFID timing tag is provided on the rear surface of the flexible planar bib. A thermal and moisture resistant layer of material is provided over the exposed outer surface the RFID tag to prevent moisture and heat from the athlete from coming into contact with the RFID tag and interfering with the ability of the tag to communicate with the antenna of a corresponding timing system. A further waterproof layer of material may be positioned between the RFID tag and the race bib to prevent moisture from soaking through the bib into the RFID tag. A laminate material may be provided to cover the entire surface.

### RELATED APPLICATIONS

The present application is a continuation-in-part of U.S. patent application Ser. No. 13/827,712 filed Mar. 14, 2013 which is a continuation of U.S. patent application Ser. No. 13/206,253, filed Aug. 9, 2011 which is a continuation of U.S. patent application Ser. No. 12/077,490, filed Mar. 20, 2008 which claims the benefit of the U.S. Provisional Patent Application Ser. No. 60/936,740, filed Jun. 22, 2007. The present application is also a continuation-in-part of U.S. patent application Ser. No. 12/856,587 filed Aug. 14, 2010 which is a continuation-in-part of U.S. patent application Ser. No. 12/732,590 filed Mar. 26, 2010. All of the foregoing applications are herein incorporated by reference in their entirety.

### FIELD OF THE INVENTION

The present invention relates to methods and apparatus for timing participants in a sporting event using Radio Frequency IDentification (RFID) systems. The invention relates to electronic timing and location devices worn by endurance athletes competing in races, and specifically relates to an improved race timing tag that is incorporated directly in the race bib, and includes one or more disposable UHF RFID tags having chips upon which data can be encoded for purposes of collecting data on an athlete during a race.

### BACKGROUND

The human spirit is competitive. Since earliest times men and women have run and raced against each other. The basic race consists of a start where someone says “GO” and everyone races to the finish line—first one across wins. A stopwatch can be used to determine the winning time.

It is easy to spot the winners—they are at the front, but it is not so simple to determine who is say “400^{th}”. Today, every runner wants to know how he or she did compared to other runners and to their “personal best” time. They want to know if they are “400^{th}” or “401^{st}”. To know that, an accurate, recorded time needs to be generated for every runner.

In a large race today, there are thousands of runners. Systems need to capture a start-time for every runner and to track when they cross the finish line, then use that data to compute that runner's elapsed time. In long races, runners also want to know what their “split times” are. They want to know what their times were when they crossed certain mile markers during the race. Further sophistication now requires that these times be posted on the internet in real time so that relatives and loved ones can use the runner's number to see when their runner passed these points.

Radio Frequency IDentification (RFID) systems typically comprise tags, sometimes referred to transponders, readers, antennas, controllers, and software. RFID systems are usually used for locating and identifying objects. RFID systems are especially useful when the number of objects is large and speed and accuracy of the process are essential. In such applications tags are attached to objects and are subsequently read by readers. The system operations are coordinated by controllers and software. Each RFID tag embeds a unique identifier and optionally other data. Readers are capable of communicating with tags and reading tags' unique identifiers. These unique identifiers are associated with objects in controllers and software.

RFID tags and readers use Radio Frequency (RF) waves to communicate. Recent advances in electronics have made it possible to manufacture tags that have no power source of their own. These tags, usually referred to as passive tags, harvest all of their power from the incident RF wave. They modulate and partially reflect the RF wave to communicate with readers. Passive tags are relatively inexpensive to manufacture and can be used as disposable tags.

In many sporting events the participants are ranked based on the time they take to complete a course. Events that have a large number of participants often use RFID systems to identify participants. The RFID systems can also be used to track the participants as they proceed through the race course.

In races that use RFID systems, race participants carry RFID tags, embedded in wrist bands or ankle straps, or attach such tags to their race bibs, shoes, bicycles, boats or other equipment. RFID readers read the tags at the start line, one or more optional mid-points, and at the finish line. For each read operation the tag's identifier and a time stamp is recorded. These records are used to calculate an event completion time for each participant. The completion times are subsequently used to rank the participants.

Current timing systems use a variety of RFID tags and readers, employing many different communication protocols, modulation schemes and frequency band. They use both passive and active tags; active tags include a power source, such as a battery. However, in all cases the readers identify each tag by a unique identifier which in this document will be referred to as the “tag number”.

Race participants are usually required to register with the race organizers prior to the start of the event. Race organizers assign a unique identification number to each participant during the registration process. In this document we will refer to this number as the “race number”. The race numbers are used to uniquely identify the participants before, during, and after the race. Race participants are usually required to carry conspicuous displays of race numbers during the event, usually referred to as “race bibs”.

To use a RFID system for timing participants in a racing event it is necessary to establish a relation between the tag numbers and the race numbers. Today, establishing such relation is labor intensive and error prone. The process typically involves manually entering tag numbers for each participant into a computer program and assuring that the correct tag is delivered to each participant along with the race bibs. The RFID tags are sometimes collected after the event for use in future events. This process is repeated for each event using the RFID system.

RFID has been used in race timing systems since 1986. Before the present invention, all of these systems used a returnable RFID chip that was attached to the runner and had to be returned to the timer following the race. These systems have significant limitations. First, the timer must build a cross-link file that correlates the unique RFID chip number to the runner's bib number. This process of building this file is time consuming and error prone. Second, after the race, each runner must wait in line to have his or her RFID chip “clipped” and returned to the timer. The event coordinator must ensure that there are sufficient volunteers to collect these RFID chips and there must be a sufficiently large and secure area to support this chip collection. If chips are not returned, the event is liable and must pay the timer for lost chips. In addition, the prior art chips are bulky and expensive to mail, so pre-registration options to improve race starts cost the event money—a not insignificant trade off. Further, the RFID controller on prior art systems is susceptible to electromagnetic interferences and must be tuned. Finally, the prior art chip controller does not have an integrated screen requiring this unit to operate externally with cables, more pieces, more packing and unpacking for the timer.

The present invention overcomes these limitations by providing a system that uses low cost, disposable UHF Gen 2 RFID Tags. The use of this tag eliminates the need for chip assignment, the cost of shipping chips to events or participants, lost chip costs and the need to create a secure zone for chip collection. The elimination of the costs for these processes directly affects the events' and timers' bottom lines. On race day, the timer can now benefit from a system that is over 99.8% accurate, does not have to be tuned, does not suffer from interference from spurious EMI sources, can be powered by its internal Li-ion batteries, external car batteries, AC generators and/or AC socket in the back of a vehicle.

### SUMMARY OF THE INVENTION

The present invention provides an all-weather option that is better suited to the logistics and pace of today's style of events. The present invention includes the use of one or more Gen2 UHF RFID tags that are used to track a runner's process during a race. The tag is incorporated directly into the runner's race bib and is comprised of disposable plastic strips about the size of bandages and has a tiny computer chip and antenna embedded in the plastic strip. The RFID tag is configured and encoded data that uniquely identifies the race and the runner's “bib” number. The RFID tag is then attached to back of the runner's bib and included in the runner's race packet. These bibs are then either mailed or hand delivered to the runner at the race expo. On race day, the athlete simply attaches the race bib to his/her shirt or shorts in the conventional manner and he/she is ready to begin the race. Because the tag is disposable, following the race, the runner simply removes the race bib and can dispose of it.

According to one aspect of the present invention, there is provided a disposable race bib timing device including a thin, flexible planar sheet member having a front surface for displaying information, and a rear surface. An RFID timing tags is affixed to the flexible planar sheet member. The RFID timing tag includes a rear surface engaging one of either the front surface or rear surface of the thin flexible planar sheet member. A thermal and moisture resistant layer of material is also provided between the RFID timing tag and the participant's garments to protect the RFID tag from interference caused by heat and moisture from the athlete. According to a further aspect of the invention, the RFID timing tag is affixed to the rear surface of the thin flexible planar sheet member.

A further aspect of the invention provides that the RFID timing tag comprises a thin, flexible planar sheet member having a front surface, and a rear surface, and a printed radio frequency identification (RFID) circuit disposed on one of the front or rear surfaces of the sheet member. The RFID circuit is disposed on the rear surface of the sheet member, according to one preferred aspect. According to this aspect of the invention, the RFID circuit includes an integrated circuit chip positioned near the center of the planar sheet member, and a dipole antenna electrically coupled to the integrated circuit chip. A first dipole of the antenna extends generally along a longitudinal axis of the sheet member toward a first end thereof and a second dipole of the antenna extends generally along the longitudinal axis of the sheet member toward a second end thereof. According to a further aspect of the invention, the first and second dipoles of the antenna extend substantially to the respective first and second ends of the flexible planar sheet. The width of the first and second dipoles of said antenna may also extend substantially across the width of the flexible planar sheet member, according to yet another aspect of the present invention.

A further aspect of the present invention provides a disposable race bib timing device wherein the thermal and moisture resistant layer of material is comprised of closed cell foam, which may preferably be between 10 and 12 mil thick.

According to yet another aspect of the invention, the disposable race bib timing device further comprises a water-proof layer of material positioned between the thin, flexible planar sheet member and the RFID timing tag. A water-resistant laminate material having a rear surface fully covering the RFID timing tag and the thermal and moisture resistant layer of material may also be provided.

Yet a further aspect of the invention is a disposable race bib timing device wherein the RFID timing tag is positioned on a rear surface of the thin, flexible planar sheet member and the thermal and moisture resistant material has a rear surface engaging a front surface of the RFID tag. A water-proof layer of material may be positioned between the thin, flexible planar sheet member and the RFID timing tag. A water-resistant laminate material having a rear surface engaging and fully covering a front surface of the thermal and moisture resistant layer of material may also be provided.

According to an alternative aspect of the invention, the thermal and moisture resistant material is positioned on a front surface of the thin, flexible planar sheet member. The RFID tag has a rear surface engaging a front surface of each one of the thermal and moisture resistant material layers. A water-proof layer of material may be positioned between the thin, flexible planar sheet member and the RFID timing tag. The water-proof layer of material may be positioned between the thin, flexible planar sheet member and the thermal and moisture resistant layer. The disposable race bib timing device may further comprise a water-resistant laminate material having a rear surface engaging and fully covering a front surface of the RFID timing tag.

Accordingly, it is an object of the present invention to provide a low cost, disposable RFID timing tag that eliminates the need for chip assignment, the cost of shipping chips to events or participants, lost chip costs and the need to create a secure zone for chip collection.

It is a further object of the present invention to provide a disposable timing tag that can accurately record information about multiple athletes at multiple locations.

These and other objects, features and advantages of the present invention will become apparent with reference to the text and the drawings of this application.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating the components of a RFID timing system that can benefit from embodiments of the current invention.

FIG. 2 is a diagram illustrating a race bib with a printed race number and attached RFID tags.

FIG. 3 is a diagram illustrating a race participant wearing multiple RFID tags.

FIG. 4 is a diagram illustrating a method for attaching RFID tags to race bibs, printing race numbers and writing to RFID tag memories.

FIG. 5 is a diagram illustrating a method for writing to RFID memories before attaching them to race bibs.

FIG. 6 is an exploded perspective view of one of the timing tags of the race bib timing device shown in FIG. 2.

FIG. 7 is an exploded perspective view of one of the timing tags according to an alternative embodiment of the present invention, positioned on the back side of a race bib.

FIG. 8 is an exploded perspective view of one of the timing tags according to an alternative embodiment of the present invention, positioned on the front side of a race bib.

### DETAILED DESCRIPTION OF PREFERRED EMBODIMENTS

The current invention is directed to methods and apparatus for associating RFID tags with race participants. The invention is also directed at improving the process of preparing and distributing RFID tags to race participants.

In accordance with the present invention the RFID tags store their data in read/write memory. The read/write memory can be accessed and modified after the tag manufacturing is complete. The ability to modify the data in tag memory allows the race organizers to associate a RFID tag with a race number and then write the correct race number or an encoding of it to the tag memory. In the simplest embodiments of the invention tag numbers, contained in the tag memory, are modified to be the same as the race numbers.

In sporting events, RFID tags and race numbers must be distributed to event participants. Race numbers are usually printed on race bibs that are worn by participants during a race. The race bibs are distributed to participants either by mail or in person prior to the race. In current systems, RFID tags, also referred to as chips, are also distributed to race participants prior to the race and are collected after the race. In such systems, the data in RFID tags are in Read Only Memory (ROM). Therefore, it is necessary to keep track of tag numbers and associate them with race numbers printed on race bibs. An embodiment of the present invention uses RFID tags with writable memory and writes the race numbers, or encodings of them, to tag memories while attaching the tags to race bibs. This process eliminates the need to distribute RFID tags and race numbers as independent entities. Event organizers need to arrange only the distribution of the race bibs to participants, eliminating the cost and effort associated with distributing and collecting RFID tags for each event.

In the following description, numerous specific details are set forth. However, it is understood that embodiments of the invention may be practiced without these specific details. In other instances, well-known devices, structures, and techniques have not been shown to avoid obscuring the understanding of this description.

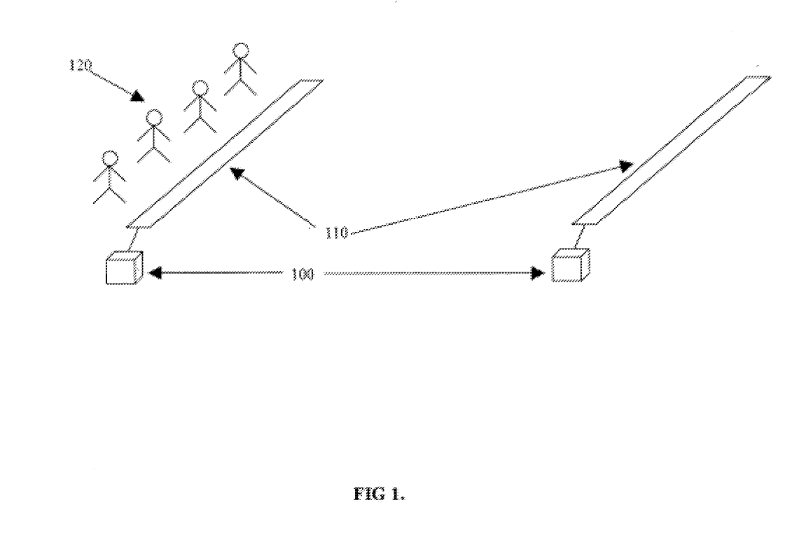

FIG. 1 shows typical components of a RFID timing system that can benefit from the embodiments of this invention. In this system exist one or a plurality of RFID readers, controllers and associated software 100, one or a plurality of antennas 110, and a plurality of participants carrying RFID tags 120. The RFID tag numbers are read as participants pass through the read field of antennas. The tag numbers and read times are recorded by the system hardware and software and are used to calculate the time each participant took to complete the course. The time durations are used to rank the participants. The participants may start the race at different times. The tag numbers and time stamps may be collected at intermediate points through out the race course.

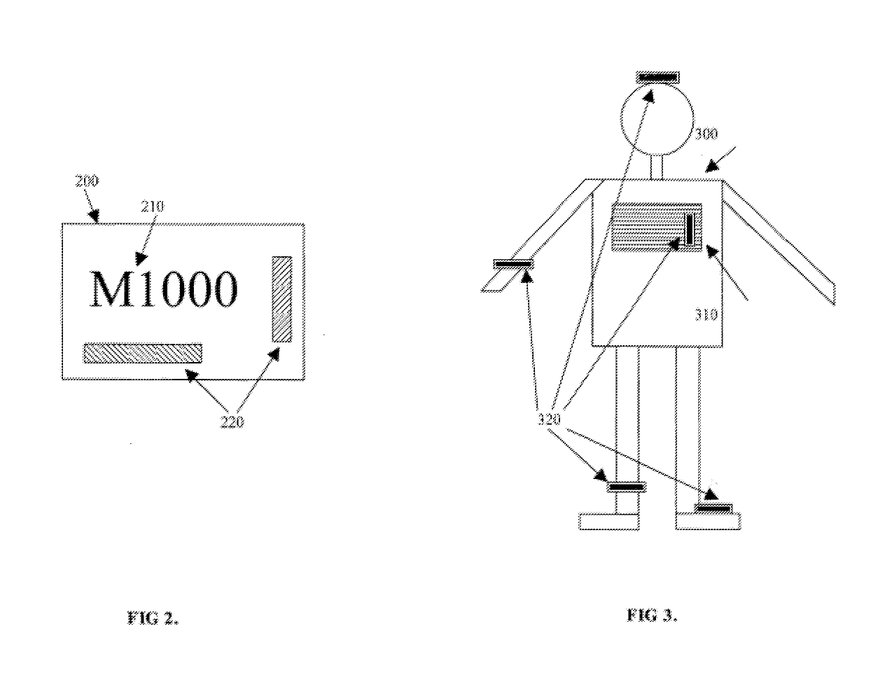

FIG. 2 shows a race bib 200 according to the present invention. It comprises a printed race number 210 and one or a plurality of RFID tags 220. The race number or an encoding of it is written to the memory in each RFID tag. The race bib 200 is preferably formed of a planar, paper-like material that can be removably affixed to the shirt, shorts or other garment of a participant in an event such as a marathon, road race, track and field event, cross country race, skiing event, biking event, triathalon, or other sporting event where participants are assigned a number for timing and/or ranking purposes. In many instances, the race bib 200 is formed of a water proof and tear resistant material, such as TYVEK.

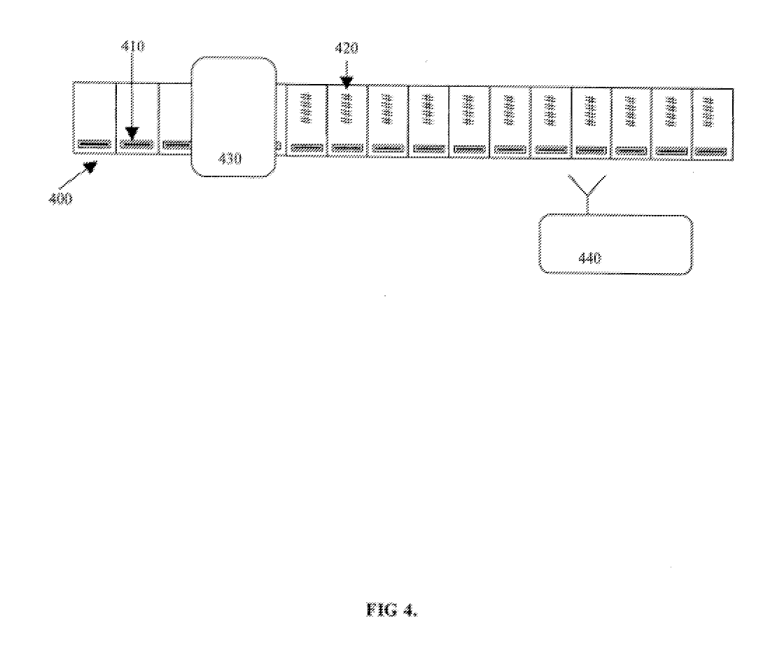

FIG. 3 shows a race participant 300 wearing a race bib 310. One or a plurality of RFID tags 320 are attached to race bibs, some of which may be detached from the bib and attached to shoes, clothing, or other apparatus such as wrist or ankle straps, helmets, bicycles, boats and clothing articles or sporting equipment.

In one embodiment of the invention, shown in FIG. 4, RFID tags 410 are attached to the race bibs 400 before race numbers 420 are printed on race bibs or are written to RFID tag memories. The race bibs are then fed through an ink printer 430 that prints the race numbers on race bibs. The bibs are then passed through a RFID printer 440 which writes the race numbers into tag memories. The ink printer and the RFID printer print and write the race numbers in the same sequence, starting from the same number. The race bibs are then separated from each other and distributed to event participants. According to the present invention it is also possible to switch the printing order such the race bibs pass through the RFID printer first and then they go through the ink printer.

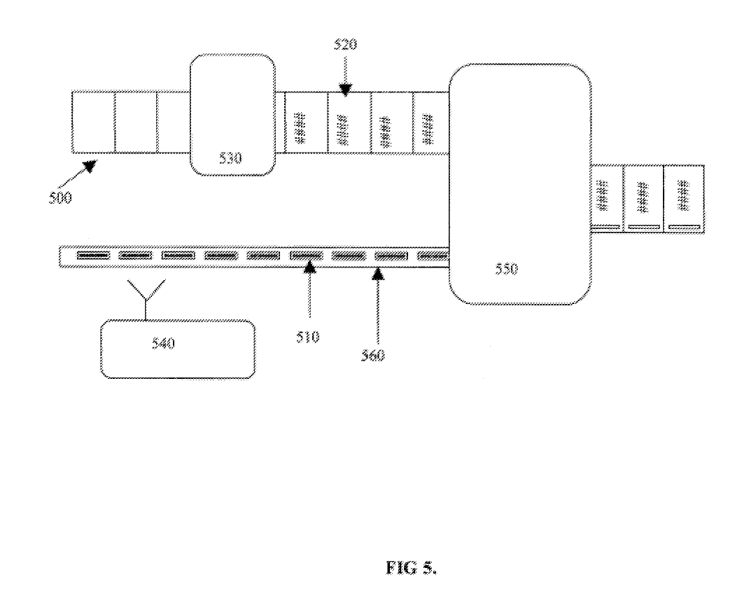

In a different embodiment of the invention, shown in FIG. 5, RFID tags 510 are attached to a backing material 560 and are passed through a RFID printer 540. The RFID printer writes the race numbers, or an encoding of them, into tag memories. In FIG. 5, the race numbers are printed on race bibs 500, by an ink printer 530. The sequence of race numbers printed by the RFID printer and the ink printer are the same. After printing, the RFID tags are transferred from the backing material to race bibs by a device 550 while preserving their order. The race bibs are then separated and distributed to race participants.

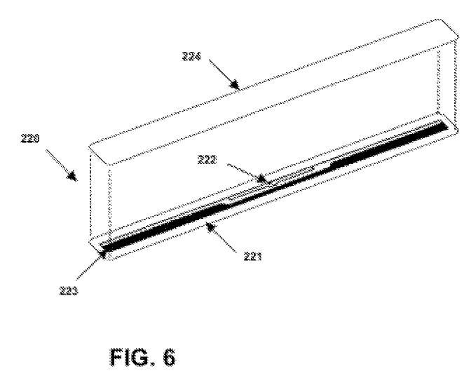

As best shown in FIG. 6, each RFID timing tag 220 is a preferably planar member 221, preferably having a substantially rectangular cross-section, and is preferably formed of a flexible, water resistant sheet type material having very low conductivity, such as sheet plastic or laminated paper. An integrated circuit 222 and antenna 223 are formed on the planar member 221 of the timing tag 220. The integrated circuit 222 and antenna 223 are preferably formed on the rear surface of the timing tag 220 to protect those components from the elements. It is also contemplated that the integrated circuit 222 and/or antenna 223 be formed on the front surface of the planar member 221 of the timing tag 220. The integrated circuit 222 is used for storing and processing information, modulating and demodulating a radio-frequency (RF) signal and other specialized functions. The integrated circuit 222 includes memory circuits and logic circuits. The logic circuits store, retrieve, and manipulate data that is encoded into the memory circuits. The logic circuits of the integrated circuit 222 receive and transmit data externally from the timing tag 220 via RF signals. The timing tag 220 is preferably a passive RFID tag, which has no battery and requires an external source to provoke signal transmission. Alternatively, the timing tag 220 could be an active RFID tag, which contains a battery and can transmit signals autonomously.

The antenna 223 is electrically connected to the integrated circuit 222 and is configured for receiving and transmitting the signal. The antenna 223 picks up signals from an RFID reader or scanner and then returns the signal, with some additional data—in this case, the runner's bib number and related information that has previously been encoded on the memory circuits of the integrated circuit 222. The antenna 223 is a conductive element that permits the timing tag 220 to exchange data with a remote reader. The antenna array is large relative to the surface of the timing tag to permit the data to be read at a distance from the transmitting antenna.

Passive RFID tags, such as are contemplated in the preferred embodiment of the present invention, make use of a coiled antenna that can create a magnetic field using the energy provided by the reader's carrier signal. A passive tag does not contain a battery; the power is supplied by the reader. When radio waves from the reader are encountered by a passive RFID tag, the coiled antenna within the tag forms a magnetic field. The tag draws power from it, energizing the circuits in the tag. The tag then sends the information encoded in the tag's memory to the reader.

The integrated circuit 222 and antenna 223 comprise a singular structure with a printed RFID circuit, thereby minimizing its profile and weight. According to one preferred embodiment of the invention, a DogBone RFID tag manufactured by UPM Raflatac is utilized. The integrated circuit used is EPC Class 1 Gen 2 compliant and 96 bit EPC memory is provided. The integrated circuit operates at a frequency of 860-960 MHZ. The antenna measures approximately 93×23 mm. According to another preferred embodiment chips from the Impinj® Monza family are used. Monza chips deliver high performance, flexible memory options, and extended features to RFID tags and can be embedded into items. Monza tag chips provide superior readability and range, support high-speed encoding and chip-based serialization, and offer exceptional quality and reliability. At present, the superior readability and range of Monza 4, Monza 5 and Monza 6 chips allow the use of a single tag on a bib. Other antenna configurations and integrated circuits may be used in keeping with the spirit of the invention.

It has been discovered through testing that the RFID tag does not operate to its potential when the integrated circuit and antenna are allowed to come in contact with moisture and heat that may be present on the surface of the participant's garment and/or skin It has also been discovered that, without the use of some shielding layer, the participant's body absorbs some of the energy from the integrated circuit 222 and antenna 223, resulting in errors. Thus, in order for the RFID tag to operate properly, in use as a timing tag, it is necessary to insure that moisture and heat from the participant do not interfere with the integrated circuit 222 and antenna 223. This is accomplished by providing a protective layer or coating 224 between the timing tag 220 and the participant. According to one presently preferred embodiment, the protective layer or coating 224 is a product known as RFIDefend produced by MPI Label Systems. The RFIDefend has a unique and proprietary material construction that provides added protection to the inlay in applications where the RFID tag is subjected to impact, abrasion, heat or moisture. It also allows the entire label to be printed without quality interference from the chip and withstands exposure to outdoor elements. According to an alternative preferred embodiment, the protective layer or coating 224 is comprised of closed cell foam. The thickness of the closed cell foam can be varied based on the particular needs of the user. However, for most purposes, providing a layer of closed cell foam in the range of 10-12 ml has been found to produce satisfactory results. Although only a single protective layer or coating 224 is shown in FIG. 6, it is contemplated to provide multiple layers and/or coatings and/or coatings of varying thicknesses to achieve the desired isolation of the RFID tag from heat and moisture from the athlete.

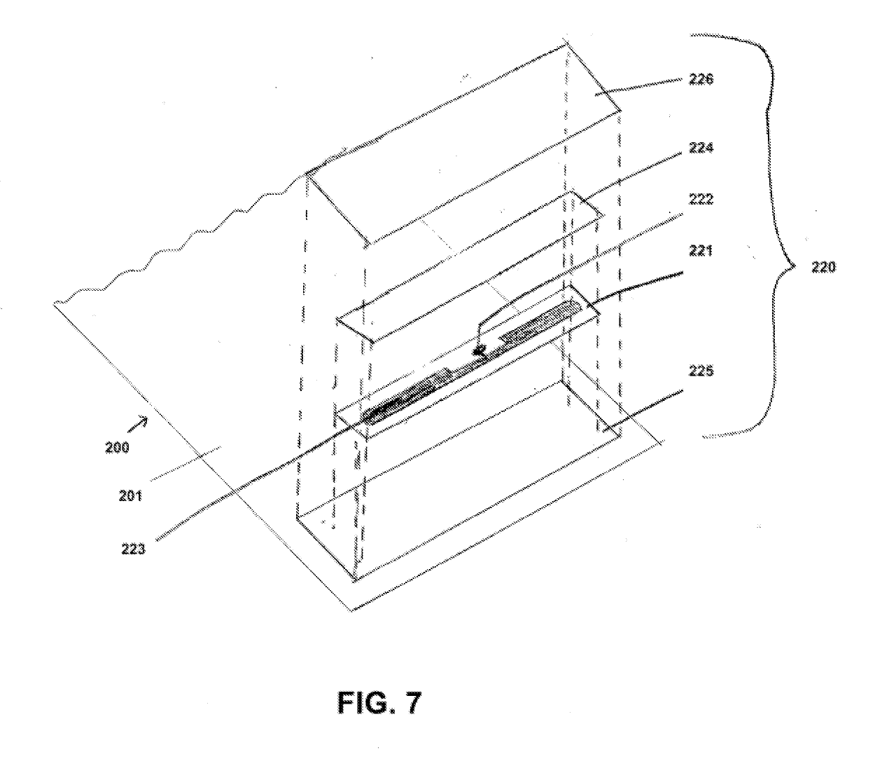

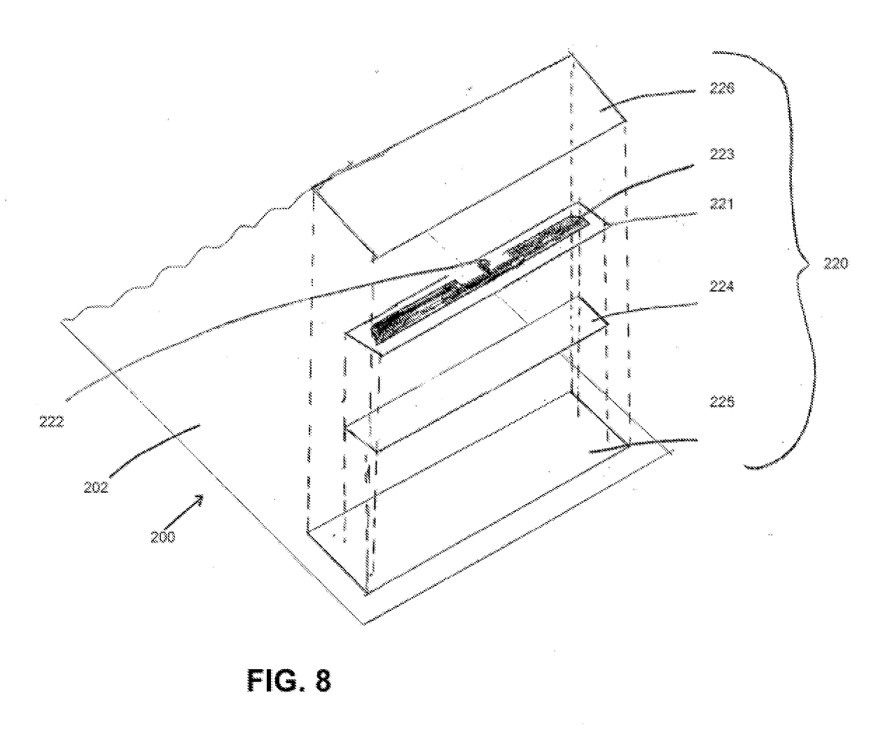

It has been discovered further through testing that over longer periods of time and in longer races (typically longer than 10K) the water resistance of the TYVEK bib material breaks down and moisture in the form of water and/or sweat may come into contact with the integrated circuit 222 and antenna 223 causing a decline in read rates of the tags as they pass over the readers. The same problem exists in shorter races where standard, non-TYVEK, paper tags are used. This problem can be overcome by providing additional water-proof and/or water-resistant layers as best shown in FIGS. 7 and 8.

In FIG. 7, a timing tag 220 according to an alternative embodiment is shown. The timing tag according to this embodiment is positioned on the back side 201 of the race bib 200, and includes additional water-proof and/or water-resistant layers 225 and 226 to protect the integrated circuit 222 and antenna 223 from moisture that may soak through the bib 200 over time. The planar member 221, integrated circuit 222, antenna 223 and protective layer or coating 224 are as described above and, accordingly, will not be further described here.

The first water-proof layer 225 is positioned between the bib 200 and the planar member 221 to prevent moisture in the form of water and/or sweat from soaking through the bib and coming into contact with the integrated circuit 222 and antenna 223. The first water-proof layer 225 acts as a vapor/water barrier between the bib 200 and planar member 221, and may be formed of any suitable water-proof material. According to one preferred embodiment of the present invention, the first water-proof layer 225 is formed from a thin sheet of polypropylene material. The second water-proof layer, or overlay, 226 is used to provide an outer water-proof seal or laminate over the planar member 221 and may also be formed of any suitable water-proof or water-resistant material. According to one preferred embodiment of the present invention, the second water-proof layer 226 is formed of a thin layer of synthetic polymer material such as nylon or polyethylene.

The primary difference between the tag shown in FIG. 7 and the tag shown in FIG. 8, is the positioning of the protective layer 224. As previously mentioned, the protective layer 224 must be positioned between the participant's body and the integrated circuit 222 and antenna 223 to shield the absorption of energy from the integrated circuit 222 and antenna 223 by the participant's body. Thus, when the tag 220 is positioned on the rear surface 201 of the bib 200 as shown in FIG. 7, the protective layer 224 is positioned between the planar member 221 and the overlay 226. Alternatively, when the tag 220 is positioned on the front surface 202 of the bib 200 as shown in FIG. 8, the protective layer 224 is positioned between the planar member 221 and first water-proof layer 225.

The foregoing is provided for purposes of illustrating, explaining, and describing embodiments of the present invention. The specific components and order of the steps listed above, while preferred is not necessarily required. Further modifications and adaptation to these embodiments will be apparent to those skilled in the art and may be made without departing from the scope or spirit of the invention.

1. A disposable race bib timing device for attachment to a race participant's garments, comprising:
a thin, flexible planar sheet member having a front surface for displaying information, and a rear surface;
an RFID timing tag having a rear surface engaging one of either the front surface or rear surface of the thin flexible planar sheet member; and
a thermal and moisture resistant layer of material positioned between said RFID timing tag and said participant's garments.

2. The disposable race bib timing device according to claim 1, wherein said RFID timing tag is affixed to the rear surface of the thin flexible planar sheet member.

3. The disposable race bib timing device according to claim 1, wherein said RFID timing tag comprises:
a thin, flexible planar sheet member having a front surface, a rear surface;
a printed radio frequency identification (RFID) circuit disposed on one of said front or rear surfaces of the sheet member, said RFID circuit including an integrated circuit chip positioned near the center of the planar sheet member, and a dipole antenna electrically coupled to said integrated circuit chip, wherein a first dipole of the antenna extends generally along a longitudinal axis of the sheet member toward a first end thereof and a second dipole of the antenna extends generally along the longitudinal axis of the sheet member toward a second end thereof.

4. The disposable race bib timing device according to claim 3, wherein the first and second dipoles of the antenna extend substantially to the respective first and second ends of the flexible planar sheet.

5. The disposable race bib timing device according to claim 6, wherein the width of the first and second dipoles of said antenna extend substantially across the width of the flexible planar sheet member.

6. The disposable race bib timing device according to claim 3, wherein the RFID circuit is disposed on the rear surface of the sheet member.

7. The disposable race bib timing device according to claim 1, wherein the thermal and moisture resistant layer of material is comprised of closed cell foam.

8. The disposable race bib timing device according to claim 7, wherein the thermal and moisture resistant layer of material is between 10 and 12 mil in thickness.

9. The disposable race bib timing device according to claim 1 further comprising a water-proof layer of material positioned between said thin, flexible planar sheet member and each of said plurality of RFID timing tags.

10. The disposable race bib timing device according to claim 9 further comprising a water-resistant laminate material having a rear surface fully covering the plurality of RFID timing tags and the thermal and moisture resistant layer of material.

11. The disposable race bib timing device according to claim 10, wherein the thermal and moisture resistant layer of material is comprised of closed cell foam.

12. The disposable race bib timing device according to claim 11, wherein the thermal and moisture resistant layer of material is between 10 and 12 mil in thickness.

13. The disposable race bib timing device according to claim 1, wherein said RFID timing tag is positioned on a rear surface of the thin, flexible planar sheet member and said thermal and moisture resistant material has a rear surface engaging a front surface of each one of said RFID tags.

14. The disposable race bib timing device according to claim 13 further comprising a water-proof layer of material positioned between said thin, flexible planar sheet member and said RFID timing tag.

15. The disposable race bib timing device according to claim 14, further comprising a water-resistant laminate material having a rear surface engaging and fully covering a front surface of the thermal and moisture resistant layer of material.

16. The disposable race bib timing device according to claim 1, wherein said thermal and moisture resistant material is positioned on a front surface of the thin, flexible planar sheet member and said RFID tag each have a rear surface engaging a front surface of each one of said thermal and moisture resistant material layers.

17. The disposable race bib timing device according to claim 16 further comprising a water-proof layer of material positioned between said thin, flexible planar sheet member and said RFID timing tag.

18. The disposable race bib timing device according to claim 17 wherein said water-proof layer of material is positioned between said thin, flexible planar sheet member and said thermal and moisture resistant layer.

19. The disposable race bib timing device according to claim 18, further comprising a water-resistant laminate material having a rear surface engaging and fully covering a front surface of the RFID timing tag.
